(19) United States
(12) Patent Application Publication
(10) Pub. No.: US 2026/0174220 A1
(43) Pub. Date: Jun. 25, 2026

(54) Paint Brush With Detachable Brush Head

(71) Applicant: Dwayne Babineaux, Fort Worth, TX (US)

(72) Inventor: Dwayne Babineaux, Fort Worth, TX (US)

(21) Appl. No.: 19/545,639

(22) Filed: Feb. 20, 2026

Related U.S. Application Data
(63) Continuation-in-part of application No. 19/033,368, filed on Jan. 21, 2025.
Application No. 19/033,368 is a continuation-in-part of application No. 17/882,240, filed on Aug. 5, 2022, now abandoned.
(60) Provisional application No. 63/284,477, filed on Nov. 30, 2021.

(51) Int. Cl. A46B 7/04; A46B 17/06; B44D 3/00

(52) U.S. Cl. CPC A46B 7/046; A46B 17/06; B44D 3/006; A46B 2200/202

(57) ABSTRACT

In aspects of a paintbrush with detachable brush head, a paintbrush may include an interchangeable handle with handle threads configured to attach or detach the interchangeable handle. The paintbrush may include a detachable brush head configured to detach from the interchangeable handle, where the detachable brush head includes a threaded receptacle with complementary threads configured for attachment with the handle threads of the interchangeable handle, or for attachment with apparatus threads of a cleaning fluid distribution apparatus.

### RELATED APPLICATIONS

This application claims priority to U.S. application Ser. No. 19/033,368 filed Jan. 21, 2025 entitled “Paint Brush with Detachable Brush Head,” the disclosure of which is incorporated by reference herein in its entirety. The U.S. application Ser. No. 19/033,368 claims priority to U.S. application Ser. No. 17/882,240 filed Aug. 5, 2022 entitled “Paint Brush,” the disclosure of which is incorporated by reference herein in its entirety. The U.S. application Ser. No. 17/882,240 claims priority to U.S. Provisional Application No. 63/284,477 filed Nov. 30, 2021 entitled “Paint Brush,” the disclosure of which is incorporated by reference herein in its entirety.

### BACKGROUND

Paintbrushes are a means to apply paint for various painting projects, such as trade painting, decoration painting, and artistic painting. Traditionally, paintbrushes are cleaned soon, if not immediately, after a paint project to extend their life. However, paintbrush cleaning can be tedious and cumbersome.

### SUMMARY

This disclosure describes one or more non-limiting implementations for a paintbrush having a detachable brush head. In one or more implementations, a paintbrush may have a detachable brush head and an interchangeable handle.

In one or more implementations of a paintbrush with detachable brush head, a paintbrush may include an interchangeable handle with handle threads configured to attach or detach the interchangeable handle; and a detachable brush head configured to detach from the interchangeable handle, the detachable brush head including a threaded receptacle with complementary threads configured for attachment with the handle threads of the interchangeable handle, or attachment with apparatus threads of a cleaning fluid distribution apparatus.

Alternatively, or in addition, aspects of the paintbrush may include any one or more of the cleaning fluid distribution apparatus is a bottle attachment and the apparatus threads are bottle threads of the bottle attachment, and the bottle attachment delivers a cleaning solution through the detachable brush head to clean oil based paint off of paintbrush bristles of the paintbrush. The cleaning fluid distribution apparatus is a water hose and the apparatus threads are water hose threads of the water hose, and the water hose delivers water through the detachable brush head to clean water based paint off of paintbrush bristles of the paintbrush. The water hose threads and the complementary threads of the detachable brush head conform to a garden hose thread standard. The handle threads of the interchangeable handle and the complementary threads of the detachable brush head conform to a garden hose thread standard.

Alternatively, or in addition, aspects of the paintbrush may include any one or more of the detachable brush head includes a ferrule top connector configured with the threaded receptacle for attachment with the interchangeable handle; a ferrule intermediate connector configured for attachment to the ferrule top connector; and a bristle holder for insertion into the ferrule intermediate connector, the bristle holder configured to hold paintbrush bristles of the paintbrush, and the bristle holder including receptacles configured to direct a cleaning fluid onto the paintbrush bristles. The detachable brush head further includes a bridge connection piece configured to interface with the bristle holder in the ferrule intermediate connector, the bridge connection piece including ports configured to align with the receptacles of the bristle holder and further direct the cleaning fluid through the ferrule intermediate connector.

Alternatively, or in addition, aspects of the paintbrush may include any one or more of the detachable brush head includes a ferrule top connector configured with the threaded receptacle for attachment with water hose threads of a water hose; a ferrule intermediate connector configured for attachment to the ferrule top connector; and a bristle holder for insertion into the ferrule intermediate connector, the bristle holder configured to hold paintbrush bristles of the paintbrush, and the bristle holder including receptacles configured to direct water through the detachable brush head onto the paintbrush bristles. The detachable brush head further includes a bridge connection piece configured to interface with the bristle holder in the ferrule intermediate connector, the bridge connection piece including ports configured to align with the receptacles of the bristle holder and further direct the water through the ferrule intermediate connector.

Alternatively, or in addition, aspects of the paintbrush may include any one or more of the detachable brush head includes a ferrule top connector configured with the threaded receptacle for attachment with bottle threads of a bottle attachment that delivers a cleaning solution; a ferrule intermediate connector configured for attachment to the ferrule top connector; and a bristle holder for insertion into the ferrule intermediate connector, the bristle holder configured to hold paintbrush bristles of the paintbrush, and the bristle holder including receptacles configured to direct the cleaning solution through the detachable brush head onto the paintbrush bristles. The detachable brush head further includes a bridge connection piece configured to interface with the bristle holder in the ferrule intermediate connector, the bridge connection piece including ports configured to align with the receptacles of the bristle holder and further direct the cleaning solution through the ferrule intermediate connector.

In one or more implementations of a paintbrush with detachable brush head, a method may include threadably attaching an interchangeable handle to a detachable brush head with handle threads of the interchangeable handle and complementary threads in a threaded receptacle of the detachable brush head; threadably detaching the interchangeable handle from the detachable brush head with the handle threads of the interchangeable handle and the complementary threads in the threaded receptacle of the detachable brush head; and threadably attaching a cleaning fluid distribution apparatus to the detachable brush head in place of the interchangeable handle, the cleaning fluid distribution apparatus threadably attached to the detachable brush head with apparatus threads of the cleaning fluid distribution apparatus and the complementary threads in the threaded receptacle of the detachable brush head.

Alternatively, or in addition, aspects of the method may include any one or more of delivering a cleaning solution through the detachable brush head to clean oil based paint off of paintbrush bristles of a paintbrush. The method further includes directing water through the detachable brush head to clean water based paint off of paintbrush bristles of a paintbrush.

In one or more implementations of a paintbrush with detachable brush head, a system may include a detachable brush head with paintbrush bristles of a paintbrush; and a threaded receptacle for attachment with an interchangeable handle or a cleaning fluid distribution apparatus, the cleaning fluid distribution apparatus configured to replace the interchangeable handle and deliver a cleaning fluid through the detachable brush head onto the paintbrush bristles.

Alternatively, or in addition, aspects of the system may include any one or more of the cleaning fluid distribution apparatus is a bottle attachment that delivers a cleaning solution through the detachable brush head to clean oil based paint off of the paintbrush bristles of the paintbrush. The cleaning fluid distribution apparatus is a water hose that delivers water through the detachable brush head to clean water based paint off of the paintbrush bristles of the paintbrush.

Alternatively, or in addition, aspects of the system may include any one or more of the detachable brush head includes a ferrule top connector configured with the threaded receptacle for attachment with the interchangeable handle; a ferrule intermediate connector configured for attachment to the ferrule top connector; and a bristle holder for insertion into the ferrule intermediate connector, the bristle holder configured to hold the paintbrush bristles of the paintbrush, and the bristle holder including receptacles configured to direct a cleaning fluid onto the paintbrush bristles. The detachable brush head includes a ferrule top connector configured with the threaded receptacle for attachment with a water hose; a ferrule intermediate connector configured for attachment to the ferrule top connector; and a bristle holder for insertion into the ferrule intermediate connector, the bristle holder configured to hold the paintbrush bristles of the paintbrush, and the bristle holder including receptacles configured to direct water through the detachable brush head onto the paintbrush bristles. The detachable brush head includes a ferrule top connector configured with the threaded receptacle for attachment with a bottle attachment that delivers a cleaning solution; a ferrule intermediate connector configured for attachment to the ferrule top connector; and a bristle holder for insertion into the ferrule intermediate connector, the bristle holder configured to hold the paintbrush bristles of the paintbrush, and the bristle holder including receptacles configured to direct the cleaning solution through the detachable brush head onto the paintbrush bristles.

In some implementations, a lowermost end of the interchangeable handle (also referred to as a detachable handle) is connectable to an upper surface of the detachable brush head. The detachable brush head may include a ferrule top connector (also referred to as a top connector piece), where a bottom end of the interchangeable handle is configured to connect into a cavity accessible from a top surface of the ferrule top connector. The detachable brush head may include a ferrule intermediate connector (also referred to as an intermediate holder) that connects to an underside of the ferrule top connector, where the ferrule top connector may be placed over the ferrule intermediate connector. The detachable brush head may include a set of paintbrush bristles that are fixedly coupled to and held in place with a bristle holder within an interior cavity of the ferrule intermediate connector, where the detachable brush head may be permanently fixed together. The detachable brush head releases from the interchangeable handle as a whole, single unit. In some implementations, the set of paintbrush bristles are inserted into a lower end of a bristle holder that is contained and held in a fixed manner within an interior cavity of the ferrule intermediate connector.

In some implementations, a bridge connection piece connects to an upper end of the bristle holder, where the bridge connection piece is configured to attach to a lower surface of the ferrule top connector. The ferrule top connector has a neck portion that merges with a wider lower portion, and a connector extension (also referred to as a shelf) extends downwardly from the lower surface of the ferrule top connector. In non-limiting implementations, the connector extension of the ferrule top connector includes a set of clip protrusions (also referred to as teeth) and flexible flaps, where the clip protrusions and the flexible flaps of the connector extension of the ferrule top connector are configured to be inserted into a corresponding set of clip holders and spaces (also referred to as gaps) that are integrated into a back side of the bridge connection piece. In non-limiting implementations, the ferrule top connector snaps together with the bridge connection piece to form an assembled unit.

In some implementations, the assembled unit is configured to fixedly attach to a top surface of the ferrule intermediate connector, where the bristle holder is contained and held in a fixed manner within an interior cavity of the ferrule intermediate connector. In non-limiting implementations, the bristle holder includes receptacles that each have a cavity extending from the top surface of each receptacle through to the bottom surface of the receptacle. In non-limiting implementations, each receptacle is configured to receive a port protruding outwardly from a bottom surface of the bridge connection piece, where a number of ports on the bridge connection piece is equivalent to the number of receptacles on the bristle holder receptacle piece. Further, each port is in vertical alignment with each corresponding receptacle when the bridge connection piece is coupled to the bristle holder receptacle piece and when the bridge connection piece and the bristle holder receptacle piece are contained within the interior cavity of the ferrule intermediate connector of the detachable brush head.

In non-limiting implementations, a width of the ferrule intermediate connector is wider than a width of the ferrule top connector of the detachable brush head. The ferrule intermediate connector includes a groove on a top surface of the ferrule intermediate connector, where the groove is configured to receive a sealing gasket. The interchangeable handle includes handle threads at the lowermost end of the interchangeable handle, where the handle threads are configured to threadably and removably mate with complementary ferrule threads contained within an interior cavity accessible from the upper surface of the ferrule top connector.

The detachable brush head is a single unit that includes the ferrule top connector, the bridge connection piece that connects onto a lower surface of the ferrule top connector, the ferrule intermediate connector, and the bristle holder, where the bristle holder and the bridge connection piece are coupled together and are both fixedly held inside of the ferrule intermediate connector. The set of paintbrush bristles are coupled to a lower surface of the bristle holder and extend downwardly away from the ferrule intermediate connector, where the bristle holder is contained within the interior cavity of the ferrule intermediate connector. In non-limiting implementations, a fluid, such as water and/or a cleaning solution, may be directed to pass through the ferrule top connector, the bridge connection piece, through the bristle holder, and onto and/or through the set of paintbrush bristles to clean the set of bristles.

### BRIEF DESCRIPTION OF THE DRAWINGS

Implementations of the techniques for a paintbrush with detachable brush head are described with reference to the following Figures. The same numbers may be used throughout to reference like features and components shown in the Figures. Features, aspects, and advantages of the present disclosure are described in the following description, appended claims, and accompanying Figures. The Figures are for illustrative purposes of one or more implementations, but not all possible implementations, and are not intended to limit the scope of the present disclosure.

FIG. 1 illustrates an example of a paintbrush with detachable brush head and interchangeable handle, in accordance with one or more implementations as described herein.

FIG. 2 illustrates an example of a paintbrush with an interchangeable handle disconnected from a detachable brush head of the paintbrush, in accordance with one or more implementations as described herein.

FIG. 3 illustrates an example of the detachable brush head and integrated paintbrush bristles with a water hose attached to the detachable brush head with water flowing through the detachable brush head, in accordance with one or more implementations as described herein.

FIG. 4 illustrates multiple examples of a detachable brush head of a paintbrush connected to a water hose bib or outdoor spigot, in accordance with one or more implementations as described herein.

FIG. 5 illustrates an example of an interchangeable handle of a paintbrush with detachable brush head, in accordance with one or more implementations as described herein.

FIG. 6 illustrates an example of a ferrule top connector of the detachable brush head of a paintbrush with detachable brush head, in accordance with one or more implementations as described herein.

FIG. 7 illustrates an example of a ferrule intermediate connector of the detachable brush head of a paintbrush with detachable brush head, in accordance with one or more implementations as described herein.

FIG. 8 illustrates an example of a bristle holder configured for insertion into the ferrule intermediate connector (shown in FIG. 7) of the detachable brush head of a paintbrush with detachable brush head, in accordance with one or more implementations as described herein.

FIG. 9 illustrates an example of a bridge connection piece configured for connection to the ferrule top connector (shown in FIG. 6) of the detachable brush head of a paintbrush with detachable brush head, in accordance with one or more implementations as described herein.

FIG. 10 illustrates an example of the bridge connection piece (shown in FIG. 9) for attachment to the ferrule top connector (shown in FIG. 6) of the detachable brush head of a paintbrush with detachable brush head, in accordance with one or more implementations as described herein.

FIG. 11 illustrates an example of paintbrush bristles integrated into the bristle holder (not shown) in the ferrule intermediate connector (shown in FIG. 7) for connection to the bridge connection piece (shown in FIG. 9), in accordance with one or more implementations as described herein.

FIG. 12 illustrates an example of the paintbrush bristles integrated into the bristle holder (shown in FIG. 8) for connection into the ferrule intermediate connector (shown in FIG. 7), in accordance with one or more implementations as described herein.

FIG. 13 further illustrates the example (shown in FIG. 12) of the paintbrush bristles integrated into the bristle holder connected into the ferrule intermediate connector with a sealing gasket for insertion into the ferrule intermediate connector, in accordance with one or more implementations as described herein.

FIG. 14 illustrates a cross-sectional view along lines I-I of the detachable brush head (shown in FIG. 3) in the example of a paintbrush with detachable brush head, in accordance with one or more implementations as described herein.

FIG. 15 illustrates an example of a bottle attachment configured to dispense a cleaning solution for attachment to the ferrule top connector (shown in FIG. 6) of the detachable brush head of a paintbrush with detachable brush head, in accordance with one or more implementations as described herein.

FIG. 16 further illustrates an example of the bottle attachment (shown in FIG. 15) attached to the ferrule top connector (shown in FIG. 6) of the detachable brush head of a paintbrush with detachable brush head, in accordance with one or more implementations as described herein.

FIGS. 17 and 18 illustrate example methods for a paintbrush with detachable brush head in accordance with one or more implementations of the techniques described herein.

### DETAILED DESCRIPTION

Implementations of the techniques for a paintbrush with detachable brush head may be implemented as described herein. Aspects of the described paintbrush with detachable brush head provide a number of solutions and advantages over conventional paintbrushes. Advantageously, a paintbrush and its components, including paintbrush bristles attached to a detachable brush head as described herein, may be cleaned with water when water based paints are used, or may be cleansed with a cleaning solution from a bottle attachment that can attach to the detachable brush head when oil based paints are used.

While features and concepts of the described techniques for a paintbrush with detachable brush head may be implemented in any number of different styles, systems, environments, and/or configurations, implementations of the techniques for a paintbrush with detachable brush head are described in the context of the following examples.

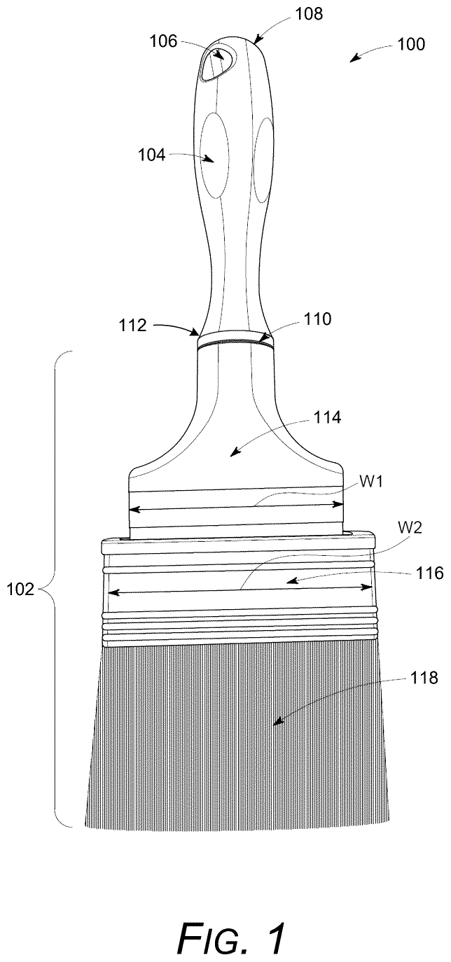

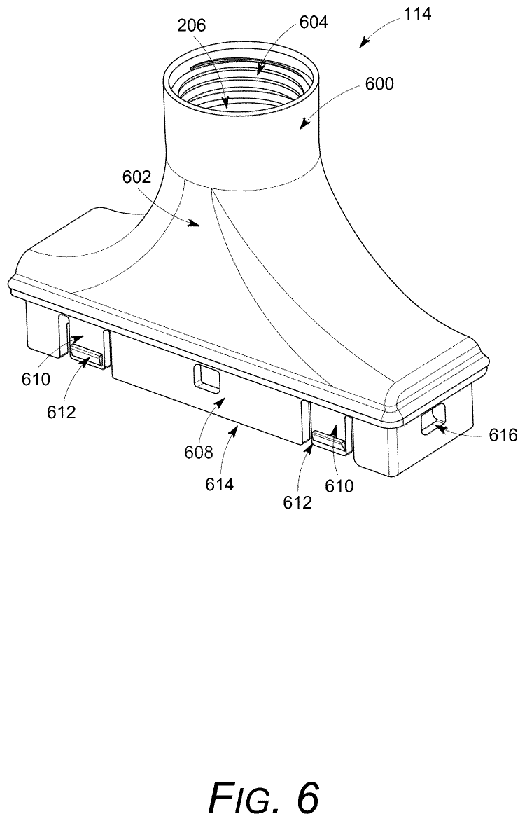

FIG. 1 illustrates an example of a paintbrush 100 with a detachable brush head 102 and an interchangeable handle 104, in a non-limiting implementation. The detachable brush head 102 (also referred to as a base portion) includes multiple components and features that may be integrated and/or connected to form the detachable brush head. The multiple components and features of the example paintbrush 100 are further illustrated and described with reference to FIGS. 6-14.

In this example of the paintbrush 100, the interchangeable handle 104 is an elongated body, and may have one or more holes or cavities 106 in a first end 108 of the interchangeable handle. In implementations, a rope or other type of grippable material may be inserted into and/or through a hole or cavity 106 in the interchangeable handle 104, which may facilitate a user holding the paintbrush and/or hanging the paintbrush. In one or more implementations, the interchangeable handle 104 is configured to detach from the detachable brush head 102 of the paintbrush 100. In aspects of the described techniques, the interchangeable handle 104 may be implemented to twist off, decouple, disconnect, and/or unscrew from the detachable brush head 102. There may be a visible joint 110 where a second end 112 of the interchangeable handle 104 and the detachable brush head 102 are joined, seated, or otherwise come together.

In one or more implementations, the detachable brush head 102 includes, but is not limited to, a ferrule top connector 114 (also referred to as a top connection piece), a ferrule intermediate connector 116 (also referred to as an intermediate holder or an intermediate connection piece), and paintbrush bristles 118 that are fixedly held within the ferrule intermediate connector 116 for use to apply any of various types of paint, such as water based paint, oil based paint, or any other type of painting applications. The paintbrush 100 may be used with any type of paint, and may be convenient for use by professional painters and/or for home or individual use. Implementations of the paintbrush 100 may also be useful as an educational tool or for a toy related purpose without limitation thereto.

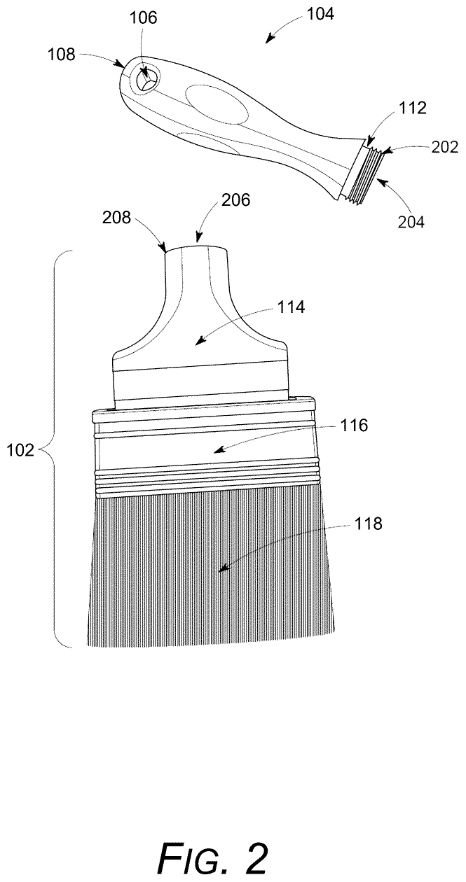

FIG. 2 illustrates an example of the paintbrush 100 with the interchangeable handle 104 detached from the detachable brush head 102. In this example, the second end 112 of the interchangeable handle 104 includes one or more handle threads 202. In one or more implementations, the handle threads 202 are integrally formed with the interchangeable handle 104, in non-limiting implementations. For example, the handle threads 202 are recessed with respect to a remainder of the body of the interchangeable handle 104. A cavity or bore 204 may extend through the interior of the interchangeable handle 104 as well.

In aspects of the described techniques, the interchangeable handle 104 and/or various different types of other interchangeable handles may be screwed onto the detachable brush head 102, as well as removed from the detachable brush head by unscrewing the handle threads 202 at the second end 112 of the interchangeable handle. The handle threads 202 of the interchangeable handle 104 are configured to mate with complementary ferrule threads (e.g., complementary ferrule threads 604 as shown in FIG. 6) of the ferrule top connector 114. In this manner, the interchangeable handle 104 can twist on and off from the detachable brush head 102, such as by the connection between the handle threads 202 and the complementary ferrule threads being tightened or loosened to cause the handle threads 202 of the interchangeable handle 104 to threadably mate or engage with, or detach from, the complementary ferrule threads that are formed within a cavity 206 of the ferrule top connector 114. The complementary ferrule threads of the ferrule top connector 114 may be visible from a top or first end 208 of the ferrule top connector 114. In one or more implementations, the shape of the first end 208 of the ferrule top connector 114 may match the shape or profile of the surface and/or shape of the second end 112 of the handle threads 202 of the interchangeable handle 104 in order for the two to mate together.

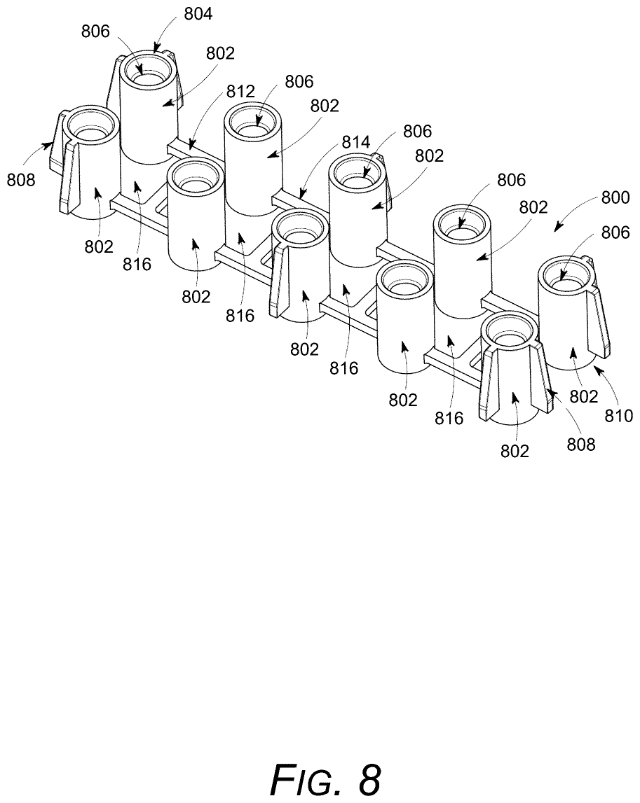

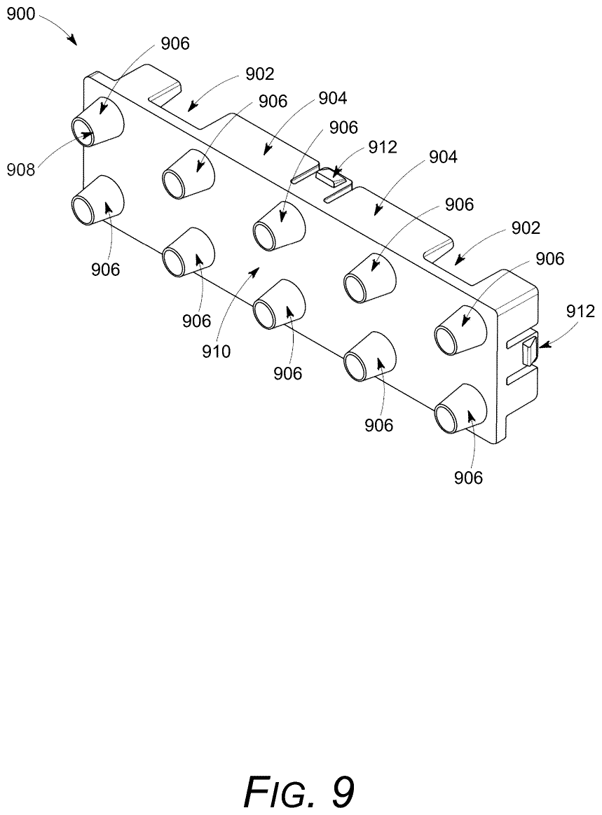

As shown in FIG. 2, the detachable brush head 102 is a complete whole unit formed from a combination of features and/or components, such as the ferrule top connector 114, the ferrule intermediate connector 116, and the paintbrush bristles 118 of the detachable brush head 102. Further interior components of the detachable brush head 102 include a bridge connection piece (e.g., a bridge connection piece 900 as shown in FIG. 9). In a non-limiting example, the bridge connection piece may have one or more ports or protrusions that can be used to direct water or a cleaning solution to flow through and clean off paint from the paintbrush bristles 118. The detachable brush head 102 may further include a bristle holder (e.g., a bristle holder 800 as shown in FIG. 8) that has one or more bristle holders or receptacles 802.

Notably, the detachable brush head 102 can be removed completely from the interchangeable handle 104 as a whole unit without any of the above-listed components of the detachable brush head being separately detached or removed during removal of the interchangeable handle, or while cleaning the paintbrush bristles 118 of the paintbrush 100. The features and/or components of the detachable brush head 102 may be fixedly held together such that the detachable brush head 102 comes apart from the interchangeable handle 104 as a single unit.

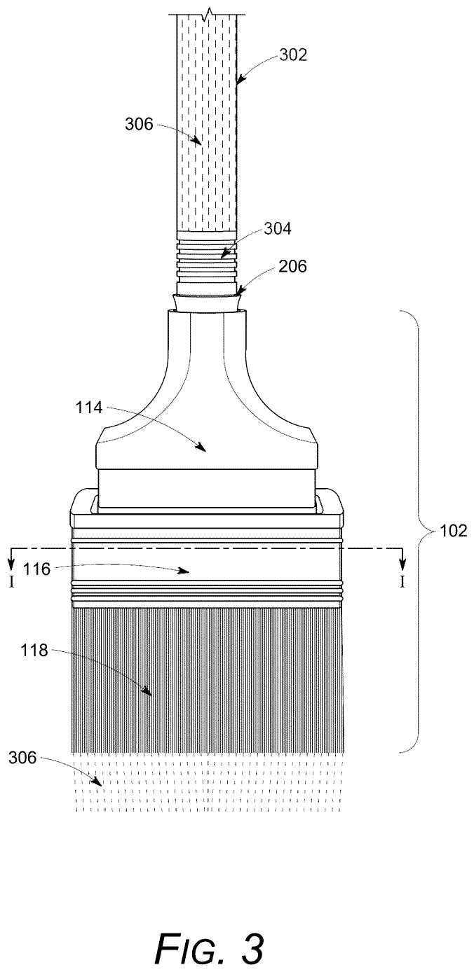

FIG. 3 illustrates an example of the detachable brush head 102 and integrated paintbrush bristles 118 with a water hose 302 that is attached to the detachable brush head 102 via one or more hose threads 304 located at the end of the water hose. In this example, the water hose 302 provides a water source that can threadably mate and engage with the complementary interior ferrule threads located within the cavity 206 of the ferrule top connector 114. In this example, water 306 runs through an interior body of the water hose 302 and through the cavity 206 of the ferrule top connector 114, through the ferrule intermediate connector 116, and out through the bottom end of the paintbrush bristles 118 grouped together. A user may also run his or her hands or use another tool to engage the water with all of the paintbrush bristles 118 for further cleaning of the bristles.

The ferrule top connector 114 includes a wide opening and exit to allow the water 306 from the water hose 302 to flow through the interior of the ferrule intermediate connector 116 and out through all of the paintbrush bristles 118. It is noted that other types of water sources may alternatively be used to provide water through the cavity 206 of the ferrule top connector 114 towards the paintbrush bristles 118 for cleaning (e.g., cleaning off water based paint with water).

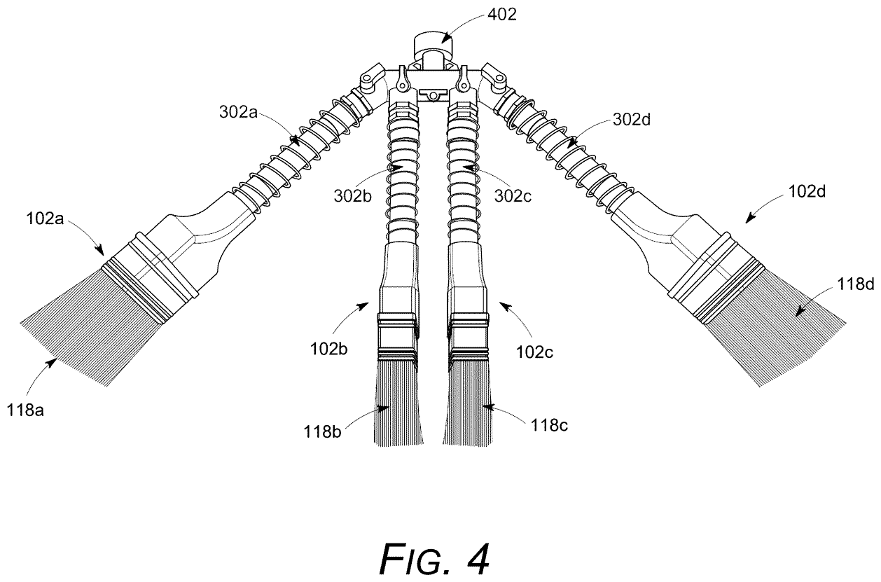

FIG. 4 illustrates multiple examples of detachable brush heads 102a-d, in non-limiting examples, and the detachable brush heads 102 may be connected to a spigot 402 (e.g., an outdoor spigot) or to a water hose bib that is configured to hold multiple attachments. It is noted that only one (or other amount) of detachable brush heads 102 may alternatively be attached to the spigot 402 for convenient cleaning of the detachable brush head(s). As further shown, a shortened water hose 302a-d may be attached to the respective attachment points of the spigot 402 for water flow through to the respective ferrule top connectors 114 of each of the detachable brush heads 102a-d and out through the ends of the paintbrush bristles 118a-d for cleaning paint off of the bristles.

Alternatively, a detachable brush head 102 may be connected directly to an attachment point or connection point of the spigot 402. For example, a detachable brush head 102 may threadably mate with an attachment point of the spigot 402 with the complementary ferrule threads of a ferrule top connector 114 without the use of an intermediate water hose 302 of any length. This example of multiple detachable brush heads 102 connected to a spigot 402 illustrates one of the many advantages of the paintbrush with detachable brush head design, in that multiple detachable brush heads 102 of multiple paintbrushes 100 may be quickly and easily cleaned together by being connected directly to an outdoor water source, such as to the spigot 402 or to a water hose 302. The paintbrush bristles 118 do not have to be separately cleaned, one at a time, in a sink for example.

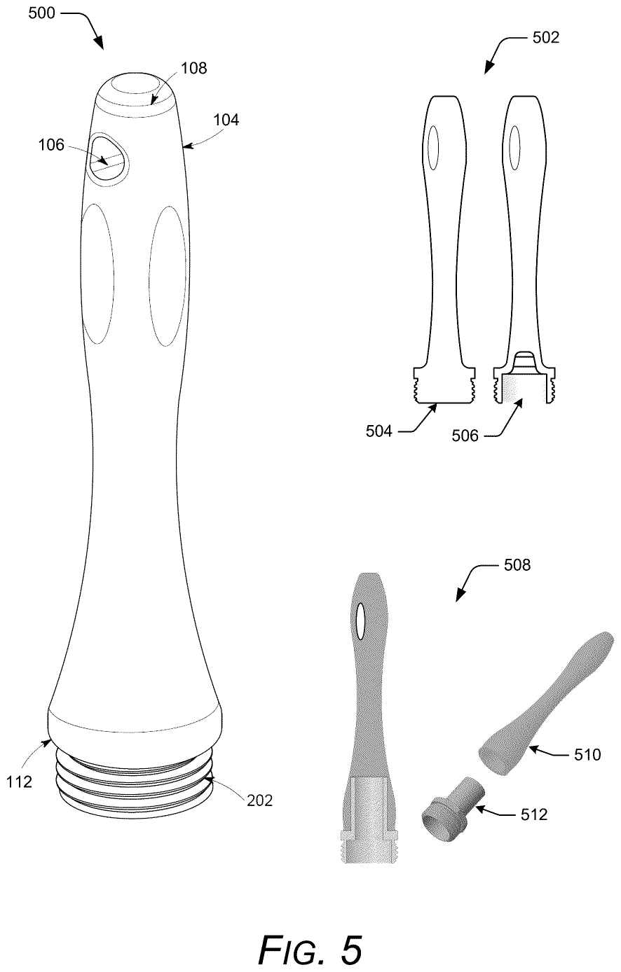

FIG. 5 illustrates an example 500 of an interchangeable handle 104, which is configured to detach from the detachable brush head 102 of a paintbrush 100. The interchangeable handle 104 may have a generally circular profile and may be narrower in the middle, in a non-limiting example, to provide a better handhold for a user. In one or more implementations, many other shapes and designs of interchangeable paintbrush handles may be implemented for use with a paintbrush with detachable brush head. For example, as shown at 502, an interchangeable handle 104 may be molded or formed in plastic or similar material with a solid core second end 112, as shown in the handle threads 202 cross-section 504. Alternatively, an interchangeable handle 104 may be molded or formed in plastic or similar material with a cavity, as shown in the handle threads 202 cross-section 506. In other implementations, as shown at 508, an interchangeable handle 104 may be formed as a wooden handle 510 with any shape and/or design, and includes a metal (or similar material) insert 512 that couples the wooden handle 510 to the ferrule top connector 114.

FIG. 6 illustrates an example of a ferrule top connector 114 of the detachable brush head 102 of a paintbrush 100, in accordance with one or more implementations as described herein. In this example, the ferrule top connector 114 has a top circular piece 600 that connects or is formed with a neck portion 602 of the ferrule top connector 114. The cavity 206 of the ferrule top connector 114 may extend all the way through the body of the entire ferrule top connector 114 so as to allow water and/or a cleaning solution to flow through an interior cavity of the ferrule top connector 114, whereby the ferrule top connector 114 acts as a conduit of the water and/or cleaning solution to other components of the detachable brush head 102 and onto and/or through the paintbrush bristles 118. In aspects of the described techniques, the top circular piece 600 of the ferrule top connector 114 includes the internal threaded receptacle with complementary ferrule threads 604 that are configured to mate with the handle threads 202 of an interchangeable handle 104. In further aspects of the described techniques, the complementary ferrule threads 604 are configured to mate with the common threads of a water hose 302 (or outdoor water spigot, or water hose bib). In one or more implementations, the handle threads 202 and the complementary ferrule threads 604 conform to the garden hose thread (GHT) standard (e.g., common for garden water hoses in North America, ¾″-11.5 GHT, straight thread, ANSI/ASME B1.20.7). In one or more implementations, other standards, such as national pipe thread (NPT) or other International equivalents, may be used or employed depending on alternative designs and application purposes.

The neck portion 602 of the ferrule top connector 114 may widen out with respect to the top circular piece 600 of the ferrule top connector 114. Alternatively, or in addition, there may be a connector extension 608 (also referred to as a shelf or ridge) that extends around a lower perimeter or lower surface of the ferrule top connector 114. In this example, the connector extension 608 has a number of flexible flaps 610 with integrated clips 612 that are configured to snap onto or otherwise attach to adjoining slots of the bridge connection piece (e.g., the bridge connection piece 900 as shown in FIG. 9). The connector extension 608 may have central pieces 614 located on the front and back of the connector extension 608 that act to span the distance between the flexible flaps 610 of the ferrule top connector 114. One or more openings 616 in the connector extension 608 may be included on the sides, the front, and the back central pieces 614 of the connector extension 608. These openings 616 may receive one or more connection elements as integrated clips (e.g., integrated clips 912 as shown in FIG. 9) located on the bridge connection piece. In non-limiting implementations, the bridge connection piece is a separate unit that directly mates and attaches to the connector extension 608 that is integrated with the ferrule top connector 114.

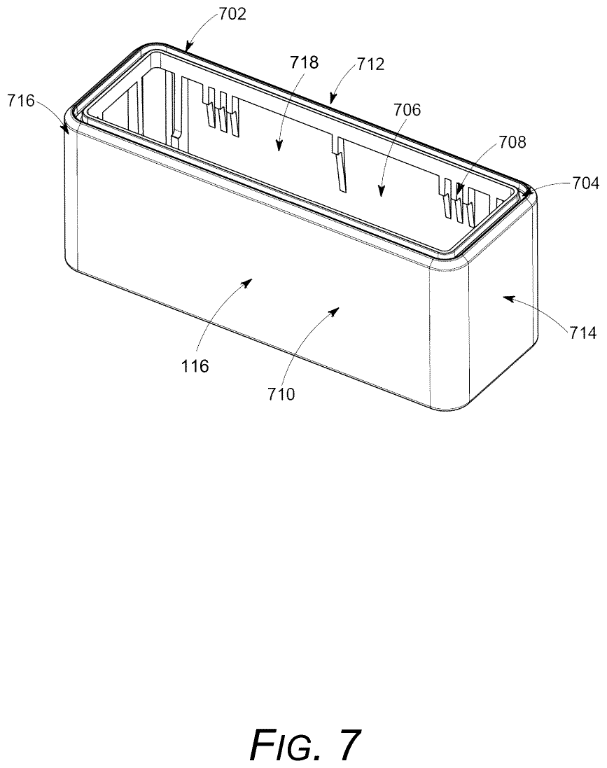

FIG. 7 illustrates an example of a ferrule intermediate connector 116 of the detachable brush head 102 of a paintbrush with detachable brush head, in accordance with one or more implementations as described herein. In aspects of the described techniques, the ferrule intermediate connector 116 is configured as a housing for the paintbrush bristles 118, as well as a housing for the bristle holder (e.g., the bristle holder 800 as shown in FIG. 8). The ferrule intermediate connector 116 is further configured as a housing for the bridge connection piece (e.g., the bridge connection piece 900 as shown in FIG. 9) when the bridge connection piece is connected to the connector extension 608 of the ferrule top connector 114, and after the bridge connection piece has been coupled to or fixedly and securely connected with the bristle holder. It is noted that the ferrule intermediate connector 116 may be implemented with metal or any other type of material that is not metal. Further, additional text or visual information may be stamped, imprinted, or otherwise included on an outside surface of the ferrule intermediate connector.

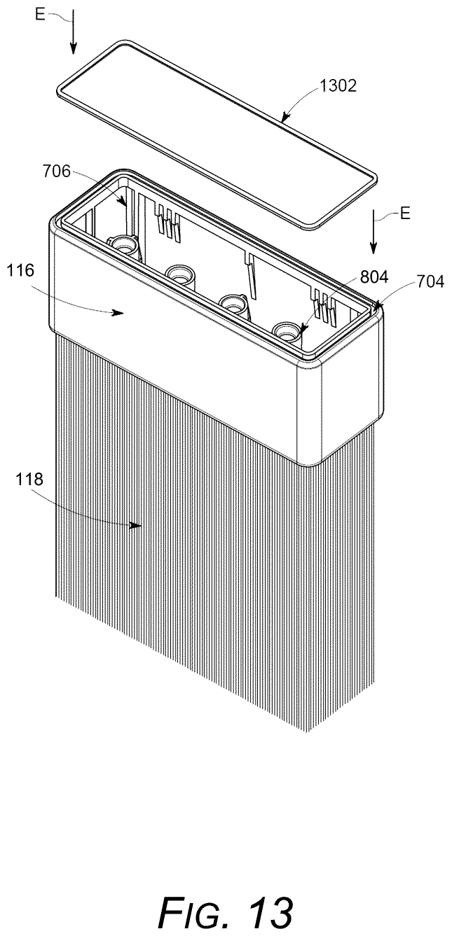

In this example, the ferrule intermediate connector 116 has a top surface 702, and an integrated, recessed groove 704 that spans the top surface 702 of the ferrule intermediate connector. A sealing gasket (e.g., a sealing gasket 1302 as shown in FIG. 13) has approximately the same rectangular shape as the ferrule intermediate connector 116, and may be inserted into the integrated, recessed groove 704 of the ferrule intermediate connector 116. The sealing gasket may be implemented to eliminate or minimize fluids leaking, such as a water leak and/or a cleaning solution leak, or any other type of fluid directed onto and/or through the paintbrush bristles 118. In one or more implementations, the ferrule intermediate connector 116 is generally rectangular in shape, having a first side 710 (e.g., a front side) that is opposite a second side 712 (e.g., a back side), where the first side 710 and the second side 712 of the ferrule intermediate connector 116 are each joined by a first end 714, and a second end 716. There may be a widened gap or cavity 706 separating the sides 710, 712, and ends 714, 716 from each other in a generally rectangular shape. There may also be one or more protruding elements 708 integrated on interior walls 718 of the ferrule intermediate connector 116, such as being integrated with the interior walls of the first side 710 and the second side 712 of the ferrule intermediate connector 116. The protruding elements 708 are configured to further connect the bridge connection piece to the interior of the ferrule intermediate connector 116.

FIG. 8 illustrates a perspective view of an example of the bristle holder 800 configured for insertion into the ferrule intermediate connector 116 of the detachable brush head 102 of a paintbrush with detachable brush head, in accordance with one or more implementations as described herein. The bristle holder 800 has any number of receptacles 802 that may each function as dual-sided receiving structures of the bristle holder 800 to hold paintbrush bristles 118 in place in the paintbrush 100. On an upper surface 804 of each receptacle 802, there may be an accessible cavity 806, into which a port (e.g., a port 906 of the bridge connection piece 900 as shown in FIG. 9) is insertable into a cavity 806 of each receptacle 802 of the bristle holder 800. In implementations, the upper surface 804 of a receptacle 802 is the side of the bristle holder 800 that is configured to face towards a surface 910 of the bridge connection piece as these components are being assembled together. Each of the receptacles 802 may include a wing element 808 that protrudes from one or more sides of a receptacle 802 and can be utilized to further facilitate connection of the receptacles 802 and/or the bristle holder 800 to the paintbrush bristles 118 and to fit within the interior cavity 706 of the ferrule intermediate connector 116.

From a lower surface 810 of the bristle holder 800, the paintbrush bristles 118 may be inserted into each receptacle 802 and held in place within the cavity 806 of each receptacle. The paintbrush bristles 118 may also be held in place with additional use of a strong and durable adhesive and/or epoxy that adhesively binds and holds the paintbrush bristles 118 in place within the respective cavities 806 of the receptacles 802. The bristle holder 800 may further include a frame structure 812 that each receptacle 802 is positioned on and/or integrated with. The receptacles 802 may be spaced a distance apart from each other on the frame structure 812 and may be separated by one or more frame structure members 814 of the bristle holder 800. In this example, the receptacles 802 may be arranged in rows and are fixedly held onto the frame structure 812, which has longer sides that include the frame structure members 814 joined in intermediate intervals with cross-members. There may also be spaces 816 between the cross-members and the receptacles 802 of the bristle holder 800.

In this example implementation, the receptacles 802 are configured in one or more rows that align in placement and position with the ports 906 as arranged on the surface 920 of the bridge connection piece. Accordingly, the number of the ports 906 corresponds to the number of receptacles 802 included on the bristle holder 800. For example, this implementation indicates that there are ten receptacles 802 included on the bristle holder 800 and the corresponding ten ports 906 included on the bridge connection piece, where each port is configured to be in alignment when facing down towards a corresponding receptacle 802.

FIG. 9 illustrates an example of a bridge connection piece 900 configured for connection to the ferrule top connector of the detachable brush head 102 of a paintbrush with detachable brush head, in accordance with one or more implementations as described herein. In this example, the bridge connection piece 900 includes the one or more ports 906 integrated onto a lower surface 910 of the bridge connection piece. In aspects of the described techniques, the one or more ports 906 are fluid transfer ports to transfer through and direct water and/or a cleaning solution onto and/or through the paintbrush bristles 118. It is noted that more or less of the ports 906 may be included on and/or integrated with the bridge connection piece in one or more implementations.

In implementations, the ports 906 are positioned on the lower surface 910 of the bridge connection piece 900, spaced apart from each other, and are raised or protrude away from the lower surface of the bridge connection piece. Additionally, there is a cavity bore 908 that extends through each fluid port 906 and opens to a back surface of the bridge connection piece, which facilitates water and/or a cleaning solution flowing through from the ferrule top connector 114. The water and/or cleaning solution is directed to flow through from the top of the ferrule top connector 114, through the cavity 206 in the ferrule top connector, through the cavity bores 908 of the ports 906 of the bridge connection piece 900 when the bridge connection piece 900 is connected to the connector extension 608 of the ferrule top connector.

In one or more implementations, the ports 906 of the bridge connection piece 900 may be cylinders that project above the lower surface 910 of the bridge connection piece, in one or more non-limiting examples. It is noted that other shapes and designs are possible, as well as ports other than as shown herein. Notably, the diameter or width of the ports 906 is less than the width or diameter of the receptacles 802 of the bristle holder 800 so that the ports 906 insert into and fit within the cavities 806 of each receptacle 802 on the bristle holder 800.

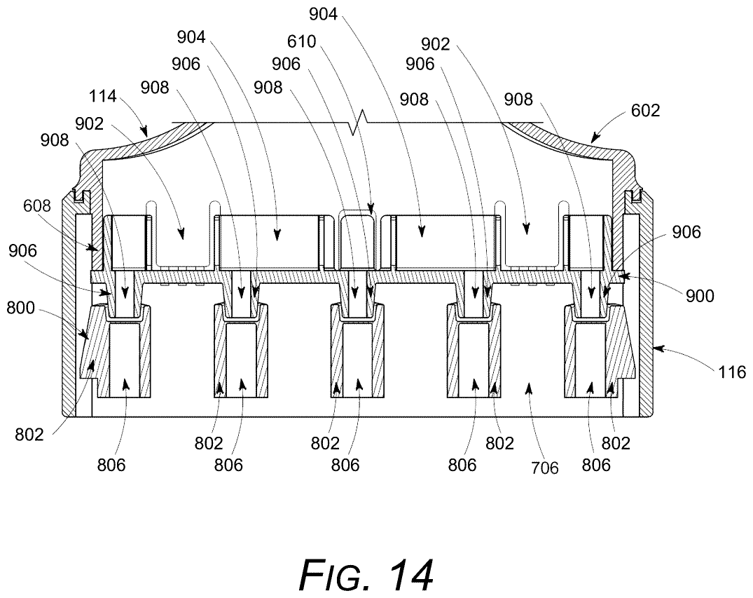

The bridge connection piece 900 may include one or more gaps, cutouts, or spaces, such as spaces 902 in bridge connection sidewalls 904 of the bridge connection piece. The bridge connection sidewalls 904 are configured to receive and hold the flexible flaps 610 that are integrated into the connector extension 608 of the ferrule top connector 114. Further, integrated clips 912 on connectors of the bridge connection piece 900 may fit into dedicated receptacles or openings 616 in the connector extension 608 of the ferrule top connector. In implementations, the bridge connection sidewalls 904 of the bridge connection piece 900 generally assist in connecting the bridge connection piece to the connector extension 608 of the ferrule top connector 114, whereby the bridge connection piece mates or connects via the different components fitting together, as further shown and described with reference to the cross-sectional view in FIG. 14.

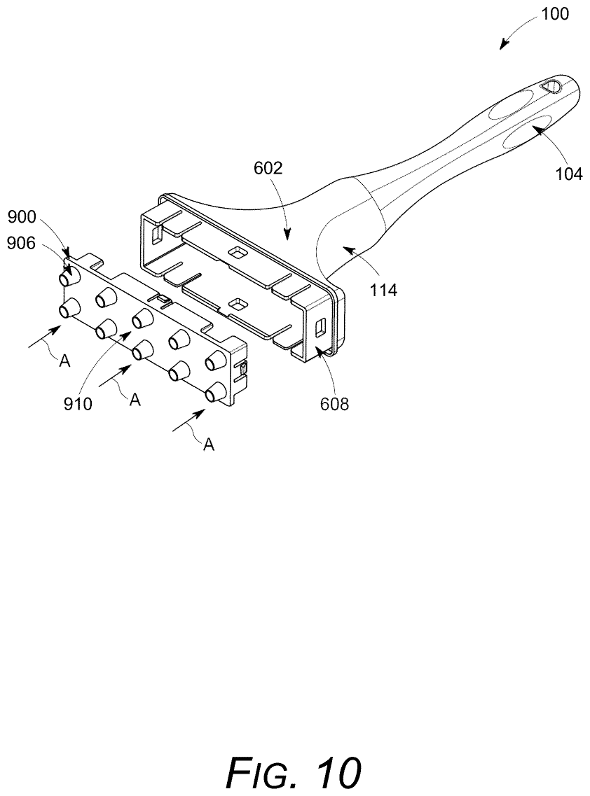

FIG. 10 illustrates an example of the bridge connection piece 900 for attachment to the ferrule top connector 114 of the detachable brush head 102 of a paintbrush with detachable brush head, in accordance with one or more implementations as described herein. For installation, the bridge connection piece 900 may be pushed into the connector extension 608 of the ferrule top connector 114 in the direction of arrows A. Notably, the back side of the bridge connection piece 900 may snap onto and/or fit by contact fit with the connector extension 608 of the ferrule top connector 114. The ports 906 of the bridge connection piece 900 will protrude from the lower surface or outward facing surface 910 of the bridge connection piece.

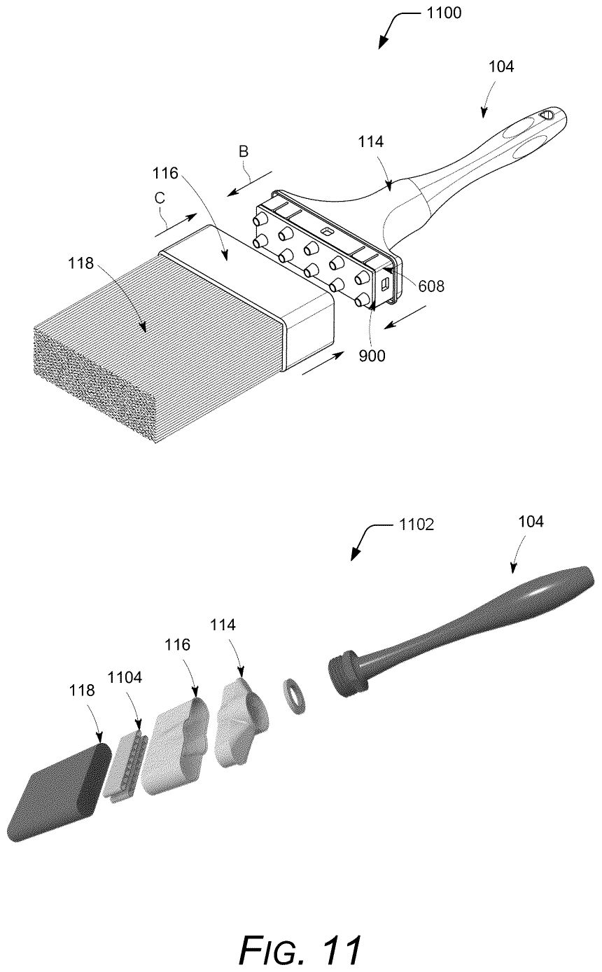

FIG. 11 illustrates an example 1100 of the paintbrush bristles 118 integrated into the bristle holder 800 installed in the ferrule intermediate connector 116 for connection to the bridge connection piece 900, in accordance with one or more implementations as described herein. This example 1100 illustrates that the ferrule intermediate connector 116 may contain the paintbrush bristles 118 and that the combination of the ferrule intermediate connector 116 and the paintbrush bristles 118 may be installed in the direction of arrow C for attachment to the assembled ferrule top connector 114 with the attached bridge connection piece 900. In one or more alternate implementations, an example 1102 of a bristle holder 1104 may be implemented as a single component that may include aspects and/or features of the bridge connection piece. Accordingly, the ferrule top connector 114 may be connected directly to the bristle holder 1104 via the integrated connector extension 608 of the ferrule top connector 114, and inside of the ferrule intermediate connector 116.

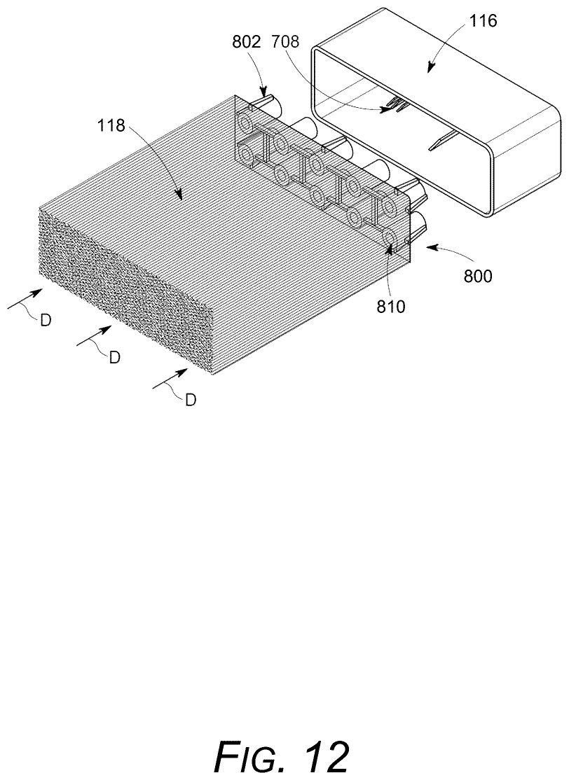

FIG. 12 illustrates an example of the paintbrush bristles 118 integrated into the bristle holder 800 for connection into the ferrule intermediate connector 116 of a paintbrush with detachable brush head, in accordance with one or more implementations as described herein. In this example, the paintbrush bristles 118 are inserted in the direction of arrow D into a lower surface 810 of each of the receptacles 802 and/or through the open spaces 816 of the bristle holder 800 (e.g., as shown in FIG. 8). In implementations, the paintbrush bristles 118 may be installed into the bristle holder 800 before the ferrule intermediate connector 116 is attached to the ferrule top connector 114 via the bridge connection piece 900.

FIG. 13 further illustrates the example (shown in FIG. 12) of the paintbrush bristles 118 integrated into the bristle holder 800 connected to the ferrule intermediate connector 116 with a sealing gasket 1302 for insertion into the ferrule intermediate connector, in accordance with one or more implementations as described herein. In this example, the sealing gasket 1302 may be inserted into the groove 704 that is formed on the top surface of the ferrule intermediate connector 116. The bristle holder 800 may be held fixedly in place within the interior cavity 706 of the ferrule intermediate connector 116. As noted above, the use of additional adhesives and/or fasteners may be used to fixedly hold the bristle holder 800 inside of the interior cavity 706 of the ferrule intermediate connector 116 and to also hold the paintbrush bristles 118 in a fixed, permanent manner in position in the bristle holder. In one or more implementations, the detachable brush head 102 is an assembled unit and the features and components are affixed together and non-removable. Further, an adhesive and/or epoxy may be poured into or otherwise applied within the internal cavities and openings to assist in permanently holding the paintbrush bristles 118 in place along with the bristle holder 800 and the bridge connection piece 900. Alternatively however, some implementations may contemplate that the features and components of the detachable brush head 102 are configured for assembly and subsequent disassembly, such as to change out or replace interchangeable components.

FIG. 14 illustrates a cross-sectional view along lines I-I of the detachable brush head 102 (shown in FIG. 3) in the example of a paintbrush with detachable brush head, in accordance with one or more implementations as described herein. In this example, the cross-sectional view shows how the ferrule top connector 114 is connected to the bridge connection piece 900 via the integrated connector extension 608 of the ferrule top connector. The spaces 902 and the bridge connection sidewalls 904 of the bridge connection piece 900 are indicated to show where the connector extension 608 of the ferrule top connector 114 may be connected to the bridge connection piece. Additionally, the bridge connection piece 900 connects to the bristle holder 800, all of which is contained within the interior cavity of the ferrule top connector 114 whereby the bridge connection piece is connected with the connector extension 608 of the ferrule top connector.

In one or more implementations, each port 906 of the bridge connection piece 900 is inserted into the corresponding and dedicated cavity 806 of the corresponding receptacle 802 of the bristle holder 800 so that the cavity bores 908 are in fluid and vertical alignment with the cavities 806, which occurs when the bridge connection piece 900 is joined with the bristle holder 800 as an assembled unit, including the interior components. In one or more alternate implementations, the bristle holder 800 and the bridge connection piece 900 may be implemented as a single, integrated component. Alternatively, the bristle holder 800 may include aspects and/or features of the bridge connection piece. Accordingly, the ferrule top connector 114 may be connected directly to the bristle holder 800 via the integrated connector extension 608 of the ferrule top connector, and inside of the ferrule intermediate connector 116.

Notably, a width W1 (e.g., as shown in FIG. 1) of the ferrule top connector 114 is less than a width W2 of the ferrule intermediate connector 116. Accordingly, the interior cavity 706 of the ferrule intermediate connector 116 is wide enough to contain the entire lower portion of the ferrule top connector 114, which includes the connector extension 608, which in turn is connected to the bridge connection piece 900 and is also connected within the interior cavity 706 of the ferrule intermediate connector 116. Further, the ferrule intermediate connector 116 can hold the bristle holder 800, which is attached to the bridge connection piece 900 in the manner described and shown with reference to FIGS. 12-14. A portion of the upper part of the paintbrush bristles 118 as held by the bristle holder 800, and may be held in place in the interior cavity 706 and covered by the ferrule intermediate connector 116, while a majority of the paintbrush bristles 118 may extend down and beneath the ferrule intermediate connector 116, such that the majority of the paintbrush bristles 118 are visible below the ferrule intermediate connector.

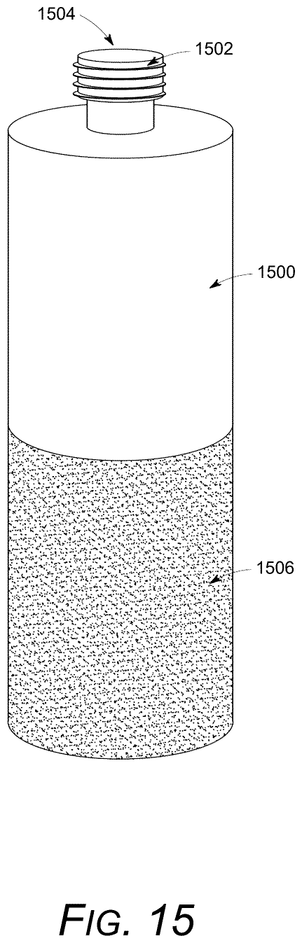

FIG. 15 illustrates an example of a bottle attachment configured to dispense a cleaning solution for attachment to the ferrule top connector 114 of the detachable brush head 102 of a paintbrush with detachable brush head, in accordance with one or more implementations as described herein. In this example, a bottle attachment 1500 includes bottle threads 1502 at an opening 1504 of the bottle attachment. While not shown, there may be a cap or lid that covers the opening 1504 of the bottle attachment 1500 when not in use to clean the paintbrush bristles 118, such as to clean oil based paint left on the paintbrush bristles. In one or more implementations, the bottle threads 1502 also conform to the garden hose thread (GHT) standard (e.g., common for garden water hoses in North America, ¾″-11.5 GHT, straight thread, ANSI/ASME B1.20.7), and are configured to mate with the complementary ferrule threads 604 of the ferrule top connector 114. The bottle attachment 1500 may be used to hold or contain a cleaning solution 1506, which in particular, may be a kind of cleaning solution that is useful in cleaning oil based paints off of the paintbrush bristles 118.

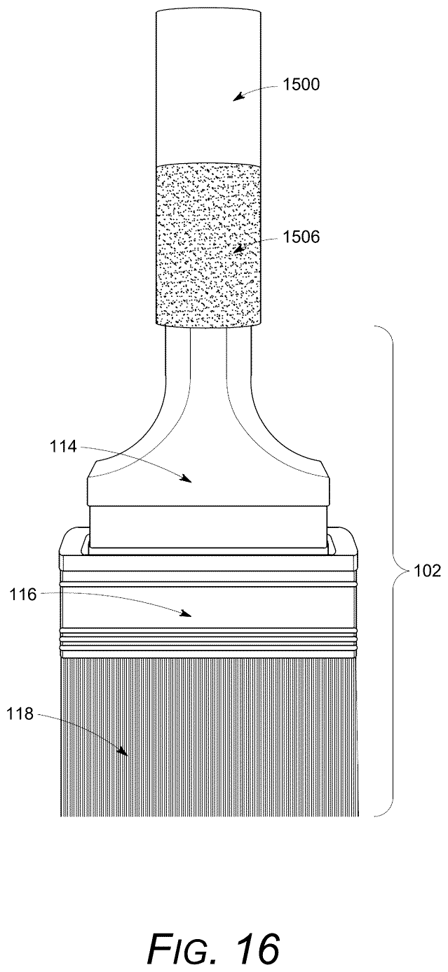

FIG. 16 further illustrates an example of the bottle attachment 1500 attached to the ferrule top connector 114 of the detachable brush head 102 of a paintbrush with detachable brush head, in accordance with one or more implementations as described herein. In this example, the bottle attachment 1500 that contains the cleaning solution 1506 may be turned upside down and threadably connected to the ferrule top connector 114 of the detachable brush head 102 by threadably engaging the bottle threads 1502 of the bottle attachment 1500 with the complementary ferrule threads 604 at the interior of the ferrule top connector 114. The cleaning solution 1506 may be directed to flow down through the opening 1504 in the top of the bottle attachment 1500, through the opening of the ferrule top connector 114 and through the ferrule intermediate connector 116 (which holds the attached bridge connection piece 900 and the bristle holder 800). The open cavity bores 908 of the respective ports 906 of the bridge connection piece 900 allow the cleaning solution to flow through the open cavity bores 908 and through the open cavities 806 of each of the receptacles 802 of the bristle holder 800, and onto and/or through the paintbrush bristles 118. Conveniently, a user can clean off any oil based paint from the paintbrush bristles 118 or the outside surfaces of the detachable brush head 102 in this manner.

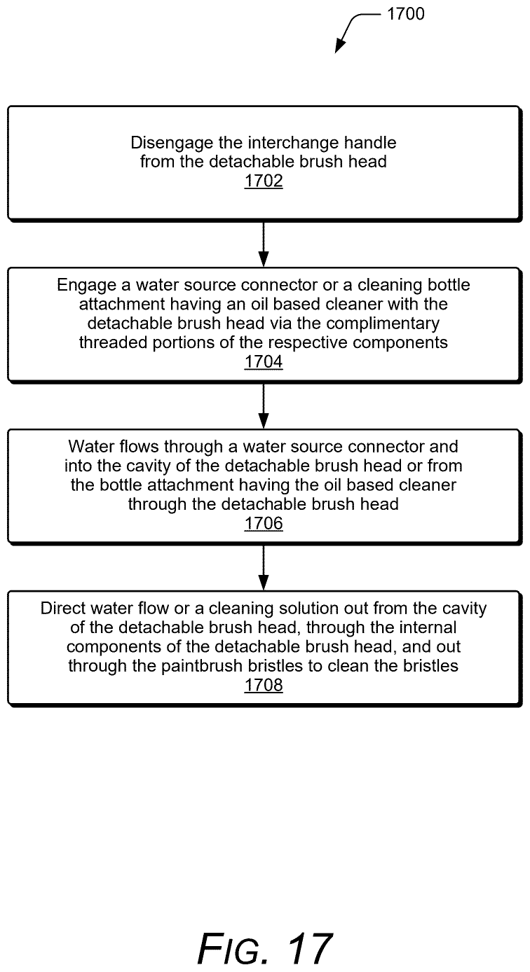

FIG. 17 illustrates an example method 1700 of a paintbrush with detachable brush head, in non-limiting examples. The order in which the method is described is not intended to be construed as a limitation, and any number or combination of the described method operations may be performed in any order to perform a method, or an alternate method.

At 1702, an interchangeable handle 104 is disengaged from the detachable brush head 102. At 1704, a water source connector is engaged (e.g., as shown in FIGS. 3 and 4) or a bottle attachment 1500 having oil based cleaner is engaged with the detachable brush head 102 via the complementary threaded portions of the respective components.

At 1706, water flows through a water source connector and into the cavity of the detachable brush head 102, or from the bottle attachment 1500 having the oil based cleaner through the detachable brush head. At 1708, the water or cleaning solution is directed to flow out and through the paintbrush bristles 118. Once cleaned, the detachable brush head 102 may be allowed to dry and then reconnected to the interchangeable handle 104 and stored for future reuse of the paintbrush 100.

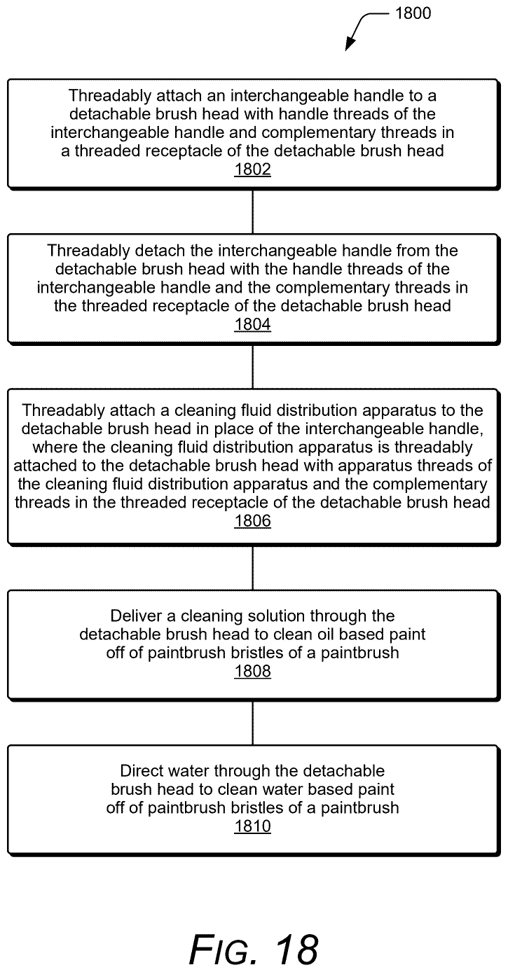

FIG. 18 illustrates example method(s) 1800 for a paintbrush with detachable brush head. The order in which the method is described is not intended to be construed as a limitation, and any number or combination of the described method operations may be performed in any order to perform a method, or an alternate method.

At 1802, an interchangeable handle is threadably attached to a detachable brush head with handle threads of the interchangeable handle and complementary threads in a threaded receptacle of the detachable brush head. For example, the complementary ferrule threads 604 of the ferrule top connector 114 threadably attach or mate with the handle threads 202 of the interchangeable handle 104.

At 1804, the interchangeable handle is threadably detached from the detachable brush head with the handle threads of the interchangeable handle and the complementary threads in the threaded receptacle of the detachable brush head. For example, the complementary ferrule threads 604 of the ferrule top connector 114 threadably detach from the handle threads 202 of the interchangeable handle 104.

At 1806, a cleaning fluid distribution apparatus is threadably attached to the detachable brush head in place of the interchangeable handle, where the cleaning fluid distribution apparatus is threadably attached to the detachable brush head with apparatus threads of the cleaning fluid distribution apparatus and the complementary threads in the threaded receptacle of the detachable brush head. For example, the complementary ferrule threads 604 of the ferrule top connector 114 threadably attach or mate with the bottle threads 1502 of the bottle attachment 1500.

At 1808, a cleaning solution is delivered through the detachable brush head to clean oil based paint off of paintbrush bristles of a paintbrush. For example, the components of the detachable brush head 102 direct a cleaning solution as delivered from the bottle attachment 1500 through the detachable brush head onto and/or through the paintbrush bristles to clean oil based paint off of the bristles.

At 1810, water is directed through the detachable brush head to clean water based paint off of paintbrush bristles of a paintbrush. For example, the components of the detachable brush head 102 direct water as delivered from a water hose through the detachable brush head onto and/or through the paintbrush bristles to clean water based paint off of the bristles.

It should be appreciated that one of the unique features of a paintbrush with detachable brush head is the detachable brush head 102 configuration which allows a user to remove and clean paint from the detachable brush head after a paint project effectively and efficiently. In addition, the paintbrush 100 ensures quality paint jobs due to the ability to store the detachable brush head 102 and the paintbrush as a whole in a clean state. Further, the detachable brush head 102 configuration ensures longevity of the paintbrush 100, thereby decreasing waste into landfills. Additionally, the design of the detachable brush head 102 enables multiple paintbrushes 100 to be easily cleaned together at one time. Many more advantages and improvements are provided by the one or more non-limiting implementations for a paintbrush with detachable brush head as described herein.

In the Summary above and in this Detailed Description, as well as in the claims and in the accompanying drawings, reference is made to particular features (including method steps) of the invention. It is to be understood that the disclosure of the invention in this specification includes all possible combinations of such particular features. For example, where a particular feature is disclosed in the context of a particular aspect or implementation of the invention, or a particular claim, that feature can also be used, to the extent possible, in combination with and/or in the context of other particular aspects and implementations of the invention, and in the invention generally.

The term “comprises” and grammatical equivalents thereof are used herein to mean that other components, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The implementations were chosen and described in order to best explain the principles of the invention and the practical application, and to enable others of ordinary skill in the art to understand the invention for various features and implementations with various modifications as are suited to the particular use contemplated. The present invention, according to one or more implementations described in the present disclosure, may be practiced with modification and alteration within the spirit and scope of the appended claims. Thus, the description is to be regarded as illustrative instead of restrictive of the present invention.

Although implementations for a paintbrush with detachable brush head have been described in language specific to features and/or methods, the appended claims are not necessarily limited to the specific features or methods described. Rather, the specific features and methods are disclosed as example implementations for a paintbrush with detachable brush head, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following claims.

1. A paintbrush, comprising:
an interchangeable handle with handle threads configured to attach or detach the interchangeable handle; and
a detachable brush head configured to detach from the interchangeable handle, the detachable brush head including a threaded receptacle with complementary threads configured for attachment with the handle threads of the interchangeable handle, or attachment with apparatus threads of a cleaning fluid distribution apparatus.

2. The paintbrush of claim 1, wherein the cleaning fluid distribution apparatus is a bottle attachment and the apparatus threads are bottle threads of the bottle attachment, and the bottle attachment delivers a cleaning solution through the detachable brush head to clean oil based paint off of paintbrush bristles of the paintbrush.

3. The paintbrush of claim 1, wherein the cleaning fluid distribution apparatus is a water hose and the apparatus threads are water hose threads of the water hose, and the water hose delivers water through the detachable brush head to clean water based paint off of paintbrush bristles of the paintbrush.

4. The paintbrush of claim 3, wherein the water hose threads and the complementary threads of the detachable brush head conform to a garden hose thread standard.

5. The paintbrush of claim 1, wherein the handle threads of the interchangeable handle and the complementary threads of the detachable brush head conform to a garden hose thread standard.

6. The paintbrush of claim 1, wherein the detachable brush head comprises:
a ferrule top connector configured with the threaded receptacle for attachment with the interchangeable handle;
a ferrule intermediate connector configured for attachment to the ferrule top connector; and
a bristle holder for insertion into the ferrule intermediate connector, the bristle holder configured to hold paintbrush bristles of the paintbrush, and the bristle holder including receptacles configured to direct a cleaning fluid onto the paintbrush bristles.

7. The paintbrush of claim 6, wherein the detachable brush head further comprises a bridge connection piece configured to interface with the bristle holder in the ferrule intermediate connector, the bridge connection piece including ports configured to align with the receptacles of the bristle holder and further direct the cleaning fluid through the ferrule intermediate connector.

8. The paintbrush of claim 1, wherein the detachable brush head comprises:
a ferrule top connector configured with the threaded receptacle for attachment with water hose threads of a water hose;
a ferrule intermediate connector configured for attachment to the ferrule top connector; and
a bristle holder for insertion into the ferrule intermediate connector, the bristle holder configured to hold paintbrush bristles of the paintbrush, and the bristle holder including receptacles configured to direct water through the detachable brush head onto the paintbrush bristles.

9. The paintbrush of claim 8, wherein the detachable brush head further comprises a bridge connection piece configured to interface with the bristle holder in the ferrule intermediate connector, the bridge connection piece including ports configured to align with the receptacles of the bristle holder and further direct the water through the ferrule intermediate connector.

10. The paintbrush of claim 1, wherein the detachable brush head comprises:
a ferrule top connector configured with the threaded receptacle for attachment with bottle threads of a bottle attachment that delivers a cleaning solution;
a ferrule intermediate connector configured for attachment to the ferrule top connector; and
a bristle holder for insertion into the ferrule intermediate connector, the bristle holder configured to hold paintbrush bristles of the paintbrush, and the bristle holder including receptacles configured to direct the cleaning solution through the detachable brush head onto the paintbrush bristles.

11. The paintbrush of claim 10, wherein the detachable brush head further comprises a bridge connection piece configured to interface with the bristle holder in the ferrule intermediate connector, the bridge connection piece including ports configured to align with the receptacles of the bristle holder and further direct the cleaning solution through the ferrule intermediate connector.

12. A method, comprising:
threadably attaching an interchangeable handle to a detachable brush head with handle threads of the interchangeable handle and complementary threads in a threaded receptacle of the detachable brush head;
threadably detaching the interchangeable handle from the detachable brush head with the handle threads of the interchangeable handle and the complementary threads in the threaded receptacle of the detachable brush head; and
threadably attaching a cleaning fluid distribution apparatus to the detachable brush head in place of the interchangeable handle, the cleaning fluid distribution apparatus threadably attached to the detachable brush head with apparatus threads of the cleaning fluid distribution apparatus and the complementary threads in the threaded receptacle of the detachable brush head.

13. The method of claim 12, further comprising:
delivering a cleaning solution through the detachable brush head to clean oil based paint off of paintbrush bristles of a paintbrush.

14. The method of claim 12, further comprising:
directing water through the detachable brush head to clean water based paint off of paintbrush bristles of a paintbrush.

15. A system, comprising:
a detachable brush head with paintbrush bristles of a paintbrush; and
a threaded receptacle for attachment with an interchangeable handle or a cleaning fluid distribution apparatus, the cleaning fluid distribution apparatus configured to replace the interchangeable handle and deliver a cleaning fluid through the detachable brush head onto the paintbrush bristles.

16. The system of claim 15, wherein the cleaning fluid distribution apparatus is a bottle attachment that delivers a cleaning solution through the detachable brush head to clean oil based paint off of the paintbrush bristles of the paintbrush.

17. The system of claim 15, wherein the cleaning fluid distribution apparatus is a water hose that delivers water through the detachable brush head to clean water based paint off of the paintbrush bristles of the paintbrush.

18. The system of claim 15, wherein the detachable brush head comprises:
a ferrule top connector configured with the threaded receptacle for attachment with the interchangeable handle;
a ferrule intermediate connector configured for attachment to the ferrule top connector; and
a bristle holder for insertion into the ferrule intermediate connector, the bristle holder configured to hold the paintbrush bristles of the paintbrush, and the bristle holder including receptacles configured to direct a cleaning fluid onto the paintbrush bristles.

19. The system of claim 15, wherein the detachable brush head comprises:
a ferrule top connector configured with the threaded receptacle for attachment with a water hose;
a ferrule intermediate connector configured for attachment to the ferrule top connector; and
a bristle holder for insertion into the ferrule intermediate connector, the bristle holder configured to hold the paintbrush bristles of the paintbrush, and the bristle holder including receptacles configured to direct water through the detachable brush head onto the paintbrush bristles.

20. The system of claim 15, wherein the detachable brush head comprises:
a ferrule top connector configured with the threaded receptacle for attachment with a bottle attachment that delivers a cleaning solution;
a ferrule intermediate connector configured for attachment to the ferrule top connector; and
a bristle holder for insertion into the ferrule intermediate connector, the bristle holder configured to hold the paintbrush bristles of the paintbrush, and the bristle holder including receptacles configured to direct the cleaning solution through the detachable brush head onto the paintbrush bristles.
